(19) United States
(12) Patent Application Publication
(10) Pub. No.: US 2023/0151310 A1
(43) Pub. Date: May 18, 2023

(54) Process for Making Flavored Alcohol Spirits

(71) Applicants: Norman R. Lasher, Astoria, NY (US); Strahinja S. Acimovic, Astoria, NY (US); Flint Whistler, Brooklyn, NY (US)

(72) Inventors: Norman R. Lasher, Astoria, NY (US); Strahinja S. Acimovic, Astoria, NY (US); Flint Whistler, Brooklyn, NY (US)

(21) Appl. No.: 17/873,421

(22) Filed: Jul. 26, 2022

Related U.S. Application Data
(63) Continuation of application No. 16/550,225, filed on Aug. 24, 2019, now abandoned.
(60) Provisional application No. 62/722,879, filed on Aug. 25, 2018.

(51) Int. Cl. C12G 3/06; G05B 19/042

(52) U.S. Cl. CPC C12G 3/06; G05B 19/0425

(57) ABSTRACT

A method of infusing a preselected substance into a base spirit in a boil kettle. The substance is added to the spirits in the kettle at programmed intervals, the length of which is programmatically determined based upon continuous machine sensing of one or more of a group of data consisting of temperature, pressure, and specific gravity, to calculate and execute each succeeding step. The mixture is heated to specific programmatically controlled temperatures for machine calculated and monitored times, and agitated selectively depending upon a preselected recipe. The data is instantaneously and continuously logged by the machine and as the mixture comes down to a programmatically selected temperature.

### CROSS REFERENCE TO RELATED APPLICATIONS

This application is a Continuation of U.S. patent application Ser. No. 16/550225 filed Aug. 24, 2019 which claims priority to U.S. Provisional Patent application 62/722879 filed Aug. 25, 2018 both of which are hereby incorporated by this reference as if fully set forth herein.

### TECHNICAL FIELD

This disclosure relates to automated industrial extraction processes; more particularly, it relates to process, product and apparatus for making flavored alcohol spirits.

### BACKGROUND

The popularity of flavored alcoholic beverages at home continues to grow. Currently, infused alcohols are available from distributors in pre-packaged bottles. While the pre-bottled beverages are well liked, many people enjoy the ability to control the ingredients added to the mix and to select the quantities and amounts used. Varying the ingredients and ensuring that no preservatives or artificial flavors are used are important factors for consumers of flavored alcoholic beverages such as those infused with fresh vegetables, fruits, and spices. For example, some consumers may prefer to infuse an alcoholic drink with a particular spice, vegetable, or fruit. Likewise, individuals who like to infuse alcohols may add spices like cinnamon or vanilla or opt for fruit flavorings like orange, lemon, or even mango, while avoiding artificial flavorings or sweeteners.

Another factor is the time it takes to flavor the alcohol with a particular flavor. Conventional methods such as conventional infusion require extensive and lengthy processes that do not optimize the potential of various fruits, vegetables, and spices to flavor an alcoholic drink in a short amount of time.

### DISCLOSURE

An automated and machine controlled method for the treatment of fruit, vegetables, or spices for the preparation of flavored alcohol spirits is provided. A selectable amount of heat and/or energy is applied to various fruits, vegetables, and spices in a machine monitored temperature-controlled and pressure-controlled environment.

An alcoholic beverage is disclosed that is specially and surprisingly infused with fruit, vegetables, or spices to which have been applied a selectable amount of heat and/or energy in a machine monitored temperature-controlled and pressure-controlled environment.

An improved method of making an alcoholic beverage is disclosed. Advantageously, the beverage is a fruited alcoholic beverage that does not need to be diluted/added to/changed prior to imbibing. Desirably, the beverage does not require any additional mixers.

### DETAILED DESCRIPTION

To a base spirit in a boil kettle selectable flavoring ingredients are added at programmed intervals, the length of which is programmatically determined based upon instantaneous machine sensing of parameters such as temperature, pressure, specific gravity, and the like, to calculate and execute each succeeding step.

The mixture is heated to specific programmatically controlled temperatures for machine calculated and monitored times, and agitated selectively depending upon the selected recipe. Timing and temperatures are variable from recipe to recipe depending on the type and quality of the fruit, vegetables, herbs or other ingredients added for flavor.

The heated mixture is then transferred to a holding kettle where more ingredients are optionally added, along with additional quantities of the spirit being used for the particular recipe. This is different from other processes in at least one way, in that everything is moved from the boil kettle to a holding tank. Moving whole fruit requires more power to pump than brewing or distillation systems generally have available.

As data is instantaneously and continuously logged by the machine, with optional adjustment of parameters such as time and temperature, and the mixture comes down to a programmatically selected temperature, the next step in the flavor transfer process is to have the mixture remain in the tank for up to 72 hours depending upon the recipe, during which it is optionally agitated or cycled on machine controlled selectable intervals, based upon continuous machine monitoring of the physical parameters of the batch.

Disclosed beverages and processes may optionally incorporate caffeine, including coffee and/or tea flavorings, nicotine, and tetrahydrocannabinol or the like.

“Liquor” refers to a beverage distilled from alcohol which is usually made from grains and fruits, but any organic substance that ferments can be used as the primary ingredient. The six primary types that typically serve as the foundation for most cocktails and mixed drinks are brandy, gin, rum, tequila, vodka and whiskey. In addition, grain alcohol and neutral spirits can also be used as foundations for various mixed drinks. Grain alcohol (or ethyl alcohol) is a double distilled spirit derived from the fermentation of grain. Grain alcohol has a higher alcohol content (i.e. , 190 proof or 95% alcohol content) than other liquors because the grain is allowed to reach a high ethanol content before being distilled.

We claim:

1. A method of infusing a preselected substance into a base spirit in a boil kettle, the method comprising the steps of:
adding the substance to the spirits in the kettle at programmed intervals, the length of which is programmatically determined based upon continuous machine sensing of one or more of a group of data consisting of temperature, pressure, and specific gravity, to calculate and execute each succeeding step;
heating the mixture to specific programmatically controlled temperatures for machine calculated and monitored times, and agitated selectively depending upon a preselected recipe;
wherein data is instantaneously and continuously logged by the machine and as the mixture comes down to a programmatically selected temperature.
